(19) United States
(12) Patent Application Publication
(10) Pub. No.: US 2005/0198833 A1
(43) Pub. Date: Sep. 15, 2005

(54) IC test fixture

(76) Inventor: Pei-Yun Lin, Taichung City (TW)

Correspondence Address: CHARLES E. BAXLEY, ESQ., 90 JOHN STREET, THIRD FLOOR, NEW YORK, NY, 10038, US

(21) Appl. No.: 10/801,399

(22) Filed: Mar. 15, 2004

(51) Int. Cl. B26D 3/16

(52) U.S. Cl. 30/131; 30/92; 30/299; 30/229

(57) ABSTRACT

A cutter comprising a first handlebar and a second handlebar, one end of which serves as coupling end to couple handlebar and the other end comprises a first cutting section, a second cutting section and a third cutting section; a bracing section extends on top of the second handlebar; a drilling plate structure fixed on the bracing section, the drilling plate comprises a cutter groove for the cutter body to cut in and semi-arc drilling grooves corresponding to the second cutting section and the third cutting section. User can apply first cutting section and the corresponding cutter groove for V-shape opening, the second cutting section and the corresponding cutter groove to cut pipes and the second cutting section and the corresponding cutter groove to cut wires.

### BACKGROUND OF THE INVENTION

I. Field of the Invention

The present invention relates to an industrial-purpose cutter, and particularly, to an integrated cutter used to cut “V-shape” openings, pipes and wires.

II. Description of the Prior Art

Heretofore, it is known that a cutter comprises two forks and two handlebars that can be opened and closed. Of the two handlebars, one end functions as a jaw for cutting and the other end functions as a handle. Under the action of a resilient member, the two handlebars are normally in open status, and when user holds the two handlebars, the jaw is coupled and thus generates cutting operation. The structure of the jaw determines what pattern of cutting operation it will generate. Normally, the jaw has the structure of straight-line cutting.

Due to such restraints as overall size, convenience for operation and cutting force, the jaw of the cutter is usually designed with single cutting function. In other words, one cutter can accomplish no more than one type of cutting. This is not cost-effective because for industrial applications, cutters of different functions are needed for onsite work, and cutters occupy precious working space and are convenient to carry about. In addition, frequent change of cutters in work may cause interruption and delay for work.

### SUMMARY OF THE INVENTION

It is therefore a primary object of the invention to provide a multifunction cutter that solves the problems of the known prior art. The present invention offers three different cutting functions in limited space.

It is still an object for the invention to provide a cutter used to cut “V-shape” openings, pipes and wires.

In order to achieve the objective set forth, a cutter in accordance with the present invention comprises:
a first handlebar and a second handlebar, one end of which serves as coupling end to couple handlebar and the other end comprises a first cutting section, a second cutting section and a third cutting section;
A bracing section extends on top of the second handlebar;
A drilling plate structure fixed on the bracing section, the drilling plate comprises a cutter groove for the cutter body to cut in and semi-arc drilling grooves corresponding to the second cutting section and the third cutting section.

User places the edge of thin plate on the drilling block of the first cutter groove, holds the handheld ends and of the said first and second handlebars and to couple the cutter body with the drilling block, the first cutter groove on the first cutting section will cut a V-shape opening on the edge of the thin plate and the cut-off V-shape piece will fall off below the first cutter groove.

User places a pipe on the pipe drilling block, holds the handheld ends and of the first and second handlebars and to couple the cutter body with the drilling block, the second cutter groove on the second cutting section will cut apart the entire pipe.

User places wire on the wire drilling block, holds the handheld ends and of the first and second handlebars and to couple the cutter body with the drilling block, the third cutting section will directly act on the wire cutting groove; when the third cutting section stops at the drilling rod, it will cut wire apart.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is an assembly view of the present invention;

FIG. 2 is a perspective view of the present invention;

FIG. 3 is a cross-sectional view of the present invention;

FIG. 4 is another cross-sectional view of the present invention;

FIG. 5 is a cross-sectional view of a further embodiment of the present invention.

FIG. 6 is another cross-sectional view of a further embodiment of the present invention;

FIG. 7 is an application view of the present invention;

FIG. 8 is another application view of the present invention;

FIG. 9 is a third application view of the present invention.

### DESCRIPTION OF THE PREFERRED EMBODIMENT

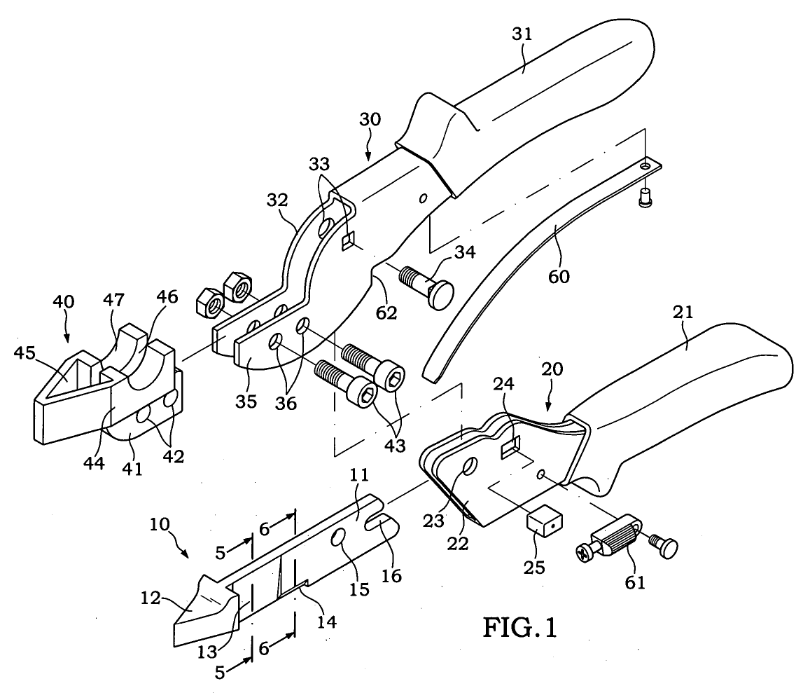

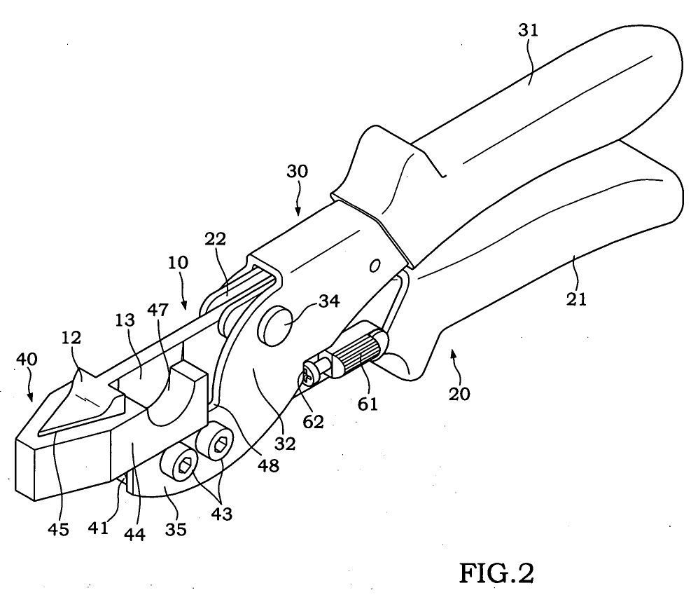

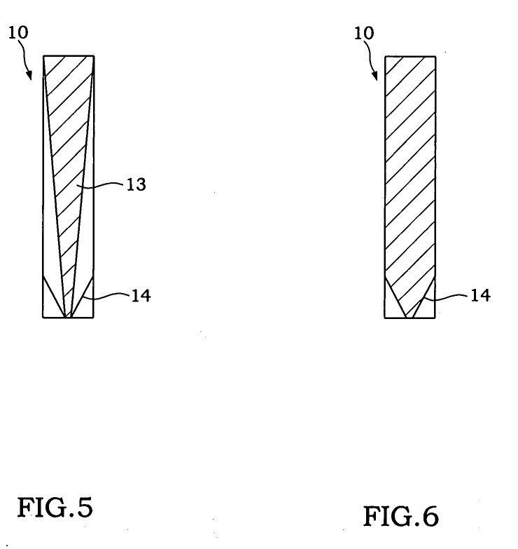

Referring to FIG. 1 to FIG. 4, the present invention comprises a cutter body 10 in long and flat in shape, one end of which serves as coupling end 11 to couple handlebar and the other end comprises a first cutting section 12, a second cutting section 13 and a third cutting section 14; wherein the first cutting section 12 comprises a triangular blade, the second cutting section 13 constitutes a conic blade (as shown in FIG. 5) on the cutter body 10 and the third cutting section 14 constitutes a blade (as shown in FIG. 6) at the bottom of the cutter body 10; the coupling end 11 comprises a hole 15 and a pin hole 16.

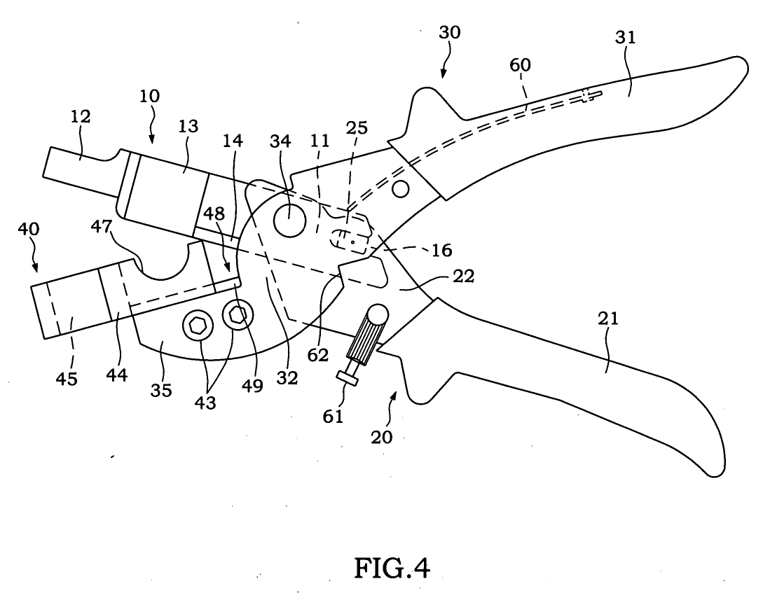

A first handlebar 20 in U-shaped in cross section (as shown in FIG. 1-to FIG. 4), one end of which serves as sleeved handheld end 21 and the other end serves as coupling section 22; the coupling end 22 sandwiches the coupling end 11 on the cutter body 10 and further comprises a hole 23 and a pin hole 24 corresponding to hole 15 and pin hole 16 on coupling end 11 such that a pin 25 is inserted through pin holes 16 and 24 to fix the first handlebar 20 and the cutter body 10.

A second handlebar 30, as shown in FIG. 1 to FIG. 4, one end of which serves as sleeved handheld end 31 having U-shape cross section and the other end serves as two-piece coupling section 32 along the two sidewalls of the said handheld end 31; the coupling end 32 sandwiches the coupling end 22 on the first handlebar 20 and further comprises a hole 33 which corresponds to holes 15 and 23 on the cutter body 10 and the first handlebar 20; wherein a component 34 is inserted to couple the above assembly such that two handlebars 20 and 30 use the component 34 as pivot to open and close. In addition, a bracing section 35 extends in front of the said coupling section 32 and comprises two fixing holes 36.

A drilling plate structure 40, as shown in FIG. 1 to FIG. 4, which comprises a fixing block 41 fully sandwiched in bracing section 35 on the second handlebar 30, and fixing holes 42 corresponding to fixing holes 36 on the bracing section 35 such that two fixing components 43 are inserted to fix the said plate structure 40 on the second handlebar 30.

A drilling block 44 is integrated on top of the fixing block 41; the drilling block 44 is partially braced at the bottom by the bracing section 35 and comprises a cutter groove for the cutter body 10 to cut in. For the purpose of description, the cutter groove is subdivided into the first cutter groove 45 and the second cutter groove 46, wherein the first cutter groove 45 is intended for the first cutting section 12 to cut in and the second cutter groove 46 is intended for the second cutting section 13 to cut in. The section of the drilling block 44 where the first cutter groove 45 is located extends beyond fixing block 41 and the first cutter groove 45 constitutes a triangular hole open on both ends; the bottom of the second cutter groove 46 is interconnected with the top of the fixing block 41; the drilling block 44 has a semi-arc drilling groove 47 on the structure corresponding to the said second cutter groove 46 and is intended for holding pipes 52 to be cut, which is referred to as pipe drilling groove 47 in the present invention; there is some distance between the drilling block 44 and the coupling section 32 of the second handlebar 30, and the distance constitutes another drilling groove 48 on drilling plate structure 40 and the drilling groove 48 is intended for holding wires 53 to be cut, which is referred to as wire drilling groove 48 in the present invention; a rigid drilling rod 49 is located on the top of the fixing block 41 corresponding to the cutting position on the first and second cutting sections 13 and 14, and executes cutting functions in coordination with the first and second cutting sections 13 and 14.

The above is the structural form of the cutter in the present invention and below is a description to specific methods concerning its operation and production.

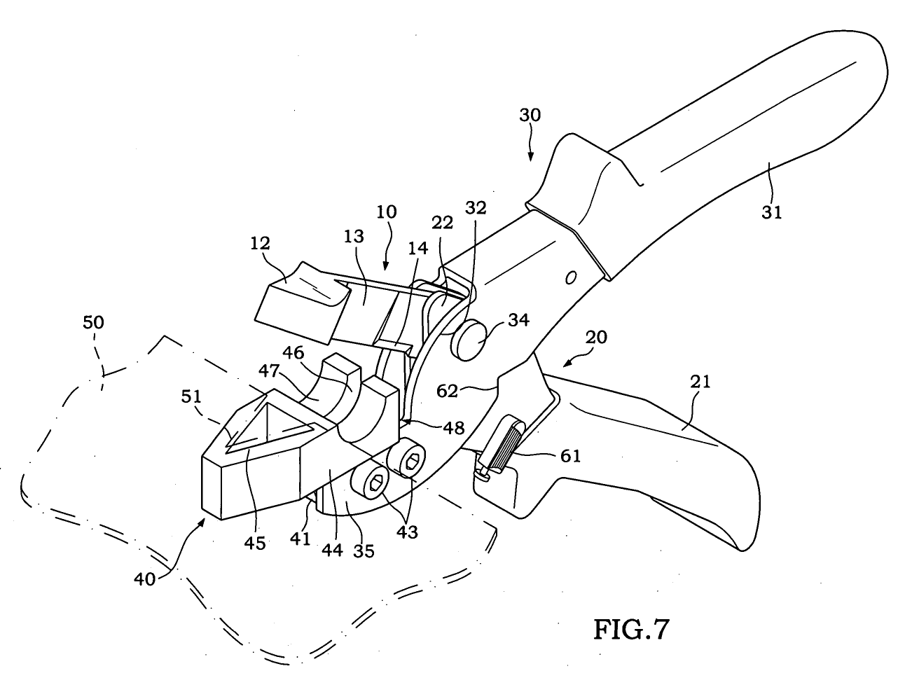

As generally known, to fold thin plates into predefined shape, for example, to fold paper materials of predefined thickness into paper boxes, cartons or corrugated shapes, it is preferred to make a V-shape opening on both ends of the paper materials that are to be folded. The purpose is to eliminate the elasticity of the section, reduce the resilience of folded edges and make thin plates easier to fold and shape. The first cutting section 12, the drilling block 44 and the first cutter groove of the cutter in the present invention have the functions of cutting V-shape openings. As shown in FIG. 7, when user places the edge of thin plate 50 on the drilling block 44 of the first cutter groove 45, holds the handheld ends 21 and 31 of the said first and second handlebars 20 and 30 to couple the cutter body 10 with the drilling block 44, the first cutter groove 45 on the first cutting section 12 will cut a V-shape opening on the edge of the thin plate and the cut-off V-shape piece will fall off below the first cutter groove 45.

The size of the V-shape opening depends on the specific location where the edge of thin plate 50 is placed on the drilling block 44. For example, if user places the edge of the thin plate in a way that it fully covers the first cutter groove 45, it will cut a maximum V-shape opening. On the other hand, if user places the edge of the thin plate in a way that it covers a small portion of the first cutter groove 45, it will cut a small V-shape opening.

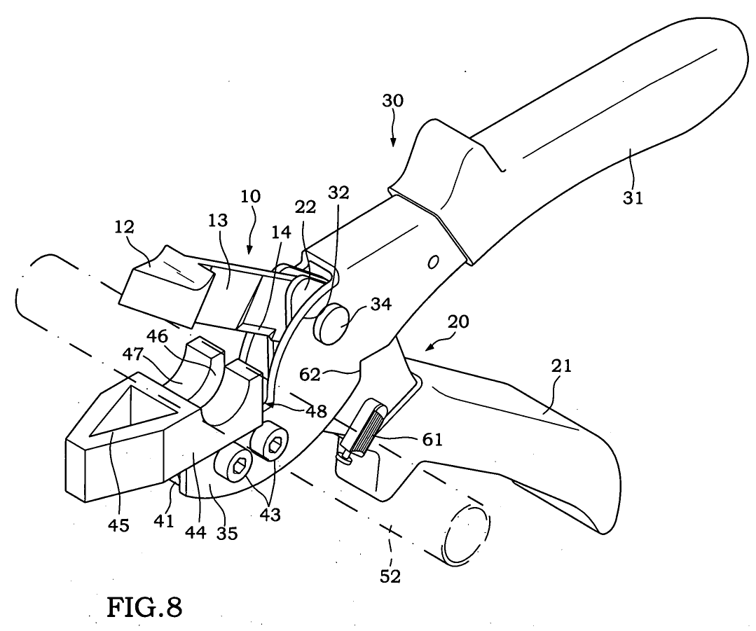

As shown in FIG. 8, when user places a pipe 52 on the pipe drilling block 47, holds the handheld ends 21 and 31 of the first and second handlebars 20 and 30 to couple the cutter body 10 with the drilling block 44, the second cutter groove 46 on the second cutting section 13 (as shown in FIG. 1 to FIG. 4) will cut apart the entire pipe 52. The semi-arc drilling groove 47 may properly hold pipe 52 and prevent it from rolling off in the process of cutting.

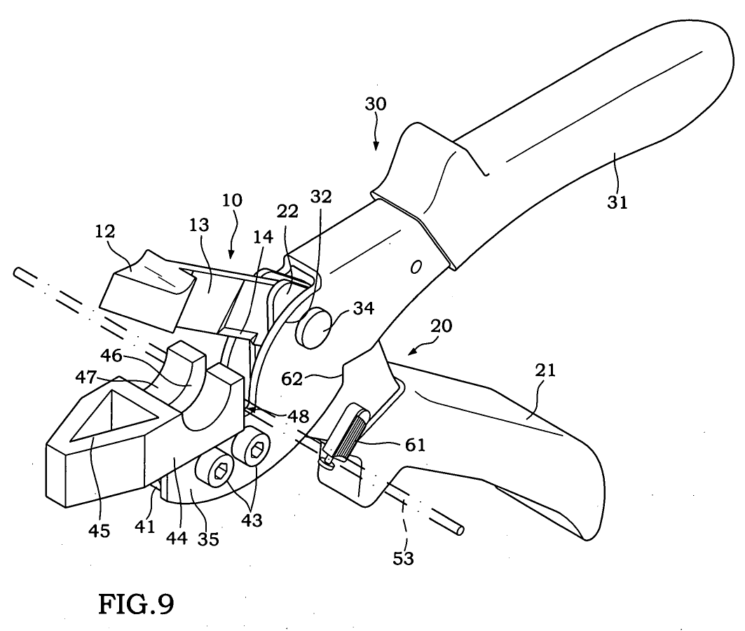

As shown in FIG. 9, when user places wire stock 53 on the wire drilling block 48, holds the handheld ends 21 and 31 of the first and second handlebars 20 and 30 to couple the cutter body 10 with the drilling block 44, the third cutting section 14 will directly act on the wire cutting groove 48; when the third cutting section 14 stops at the drilling rod 49 (as shown in FIG. 4), it will cut wire 53 apart.

As described above, the drilling block 44 is partially braced at the bottom by the bracing section 35, and fixing components 43 fix the fixing block 41 of the drilling block 44 on the bracing section 35 such that fixing block 44 is firmly fixed and can bear the cutting force applied to it by the cutter body 10 without causing instability.

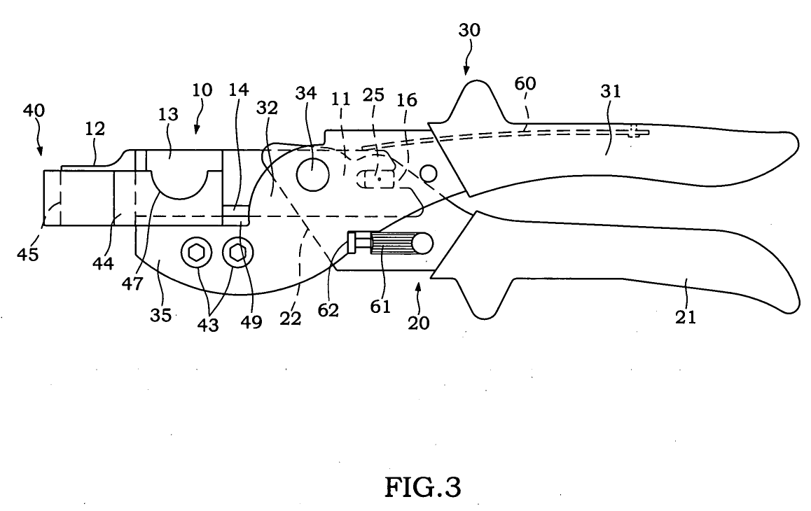

As shown in FIG. 1, FIG. 3 and FIG. 4, a resilient member 60 (spring for example) acts on the first and second handlebars 20 and 30 such that the cutter body 10 and the cutting plate structure 40 are normally in open status; however, when user holds the two handheld ends 21 and 31, the force thus generated couples the cutter body 10 with the drilling plate structure 40 and creates cutting force. On the other hand, when the cutter is in closed status, it is suitable for safekeeping; in open status, the cutter tends to be propelled open by the said resilient member 60. A rotatable stop bar 61 and a recess 62 are provided at proper locations on the first and second handlebars 20 and 30 such that when the cutter is closed, the stop bar 61 can rotate into the recess 62 and the cutter is folded and well positioned; or, when the stop bar 61 rotates off the recess 62, the cutter will pop up into open status.

Te present invention applies space in the cutter body 10 to provide the first cutting section 12, the second cutting section 13 and the third cutting section 14, and uses the limited space on the drilling plate structure 40 to provide the first cutter groove 45, the second cutter groove 46, the pipe drilling groove 47 and wire drilling groove 48 such that all these structures coordinate with the cutting sections. As a result, the cutter in the present invention can cut V-shape openings, pipes and wires, thus becoming a multifunctional integrated cutter.

While a preferred embodiment of the invention has been shown and described in detail, it will be readily understood and appreciated that numerous omissions, changes and additions may be made without departing from the spirit and scope of the invention.

1. A cutter comprising:
a first handlebar and a second handlebar, one end of which serves as coupling end to couple handlebar and the other end comprises a first cutting section, a second cutting section and a third cutting section;
a bracing section extends on top of said second handlebar;
a drilling plate structure fixed on said bracing section, said drilling plate comprises a cutter groove for the cutter body to cut in and semi-arc drilling grooves corresponding to said second cutting section and said third cutting section.

2. The cutter recited in claim 1, wherein said first cutting sections is in triangle blade.

3. The cutter recited in claim 1, wherein the cross section of said second cutting section is in conic blade.

4. The cutter recited in claim 1, wherein the bottom of said third cutting section is a blade

5. The cutter recited in claim 1, wherein said drilling plate structure comprises a fixing block, a drilling block is integrated on top of said fixing block, and said drilling block is partially braced at the bottom by said bracing section and comprises a cutter groove and drilling grooves.

6. The cutter recited in claim 5, wherein partial of said drilling block is supported by the top of said bracing section.

7. The cutter recited in claim 5, wherein said fixing block is fastened onto said bracing section with two fixing components.

8. The cutter recited in claim 5, wherein the section of said drilling block where said first cutter groove is located extends beyond said fixing block.

9. The cutter recited in claim 8, wherein said first cutter groove constitutes a triangular hole open on both ends.

10. The cutter recited in claim 9, wherein the bottom of said second cutter groove and third cutter groove is interconnected with the top of said fixing block.

11. The cutter recited in claim 10, wherein a rigid drilling rod is located on the top of said fixing block.

12. The cutter recited in claim 5, wherein said drilling groove is in semi-arc shape and is for pipes to be cut.

13. The cutter recited in claim 5, wherein the said drilling groove is in semi-arc shape and is for wires to be cut.

14. The cutter recited in claim 1, wherein said first handlebar and said cutter body further comprise a pin hole such that a pin is inserted through pin holes to fix said first handlebar and said cutter body.
